(19) United States
(12) Patent Application Publication
(10) Pub. No.: US 2026/0301741 A1
(43) Pub. Date: Oct. 1, 2026

(54) SPEECH TRANSCRIPTION BY AN ELECTRONIC DEVICE ON AUDIO DETECTION OF A PARTICIPANT SIDE CONVERSATION DURING A COMMUNICATION SESSION

(71) Applicant: MOTOROLA MOBILITY LLC, WILMINGTON, DE (US)

(72) Inventors: RANJEET GUPTA, AURORA, IL (US); RAHUL BHARAT DESAI, HOFFMAN ESTATES, IL (US)

(21) Appl. No.: 19/094,957

(22) Filed: Mar. 30, 2025

(51) Int. Cl. G10L 15/26; G06F 16/34; G10L 25/78; H04N 7/15

(52) U.S. Cl. CPC G10L 15/26; G06F 16/345; G10L 25/78; H04N 7/15

(57) ABSTRACT

An electronic device, a method and a computer program product for transcribing speech from a communication session to text in response to detecting a local participant in a side conversation. The method includes, in response to identifying that an audio transmission feature to the communication session of the local participant is set to a muted mode, monitoring for detection of audio input including spoken speech originating from an area external to the electronic device. The method includes detecting whether there is a non-participant in a vicinity of the local participant. In response to detecting the audio input includes spoken speech and detecting a presence of a non-participant, the method includes identifying speech input received via the communication session from a remote participant. The method includes generating at least one of a text transcript and summary of the speech input and visually presenting the text transcript or summary.

### BACKGROUND

### 1. Technical Field

The present disclosure generally relates to electronic devices and in particular to electronic devices that enable a communication session between electronic devices.

### 2. Description of the Related Art

Electronic devices, such as mobile phones, tablets, and laptops, are widely used for video, voice, and text communication and for data transmission. Many conventional electronic devices have at least one front facing camera and one or more rear facing cameras, along with one more display devices. Additionally, electronic devices used to conduct communication also have at least one microphone, with some devices having both a front microphone and rear microphone. Electronic devices with cameras and microphones can be used to conduct audio and video conferences or calls with one or more other electronic devices. During an audio or video conference, a user may experience interruptions or distractions from family or co-workers. A user may start a conversation with a family member or co-worker while also participating in an ongoing audio or video conference with remote participants.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices and several image capturing devices, according to one or more embodiments;

FIG. 1C is an example illustration of the front of an electronic device with a front display and multiple front cameras, according to one or more embodiments;

FIG. 1D is an example illustration of the rear of an electronic device with a rear display and multiple rear cameras, according to one or more embodiments;

FIG. 2 is an example block diagram of an audio/video (AV) communication session environment, according to one or more embodiments;

FIG. 3 is a block diagram of example contents of the memory subsystem of the example electronic device of FIG. 1A-1B (FIG. 1), which configures the electronic device to complete the various processes described herein, according to one or more embodiments;

FIG. 4 illustrates an example electronic device being used during a AV communication session to capture live audio and video of a local participant of the AV communication session, according to one or more embodiments;

FIG. 5 illustrates an example of a local participant of the AV communication session of FIG. 4 engaged in a side conversation with a non-participant during the AV communication session, according to one or more embodiments;

FIG. 6A illustrates an example setup graphical user interface (GUI) presented on a display of an electronic device, according to one or more embodiments; and

FIG. 6B illustrates an example AV communication session GUI, with a text transcript, being presented on a display of an electronic device responsive to detection of a side conversation, based on user pre-selection of a text transcript user-selectable option, according to one or more embodiments;

FIG. 6C illustrates an example AV communication session GUI, with a summary, being presented on a display of an electronic device responsive to detection of a side conversation, based on user pre-selection of a summary user-selectable option, according to one or more embodiments;

FIG. 6D illustrates an example AV communication session GUI with a local participant and several other remote participants and a text transcript being presented on an external display, according to one or more embodiments;

FIG. 6E illustrates an example text transcript/summary selection GUI presented on a display of an electronic device, according to one or more embodiments; and

FIGS. 7A-7B (FIG. 7) depicts a flowchart of a method by which an electronic device transcribes speech from a communication session to text in response to detecting a local participant of the communication session in a side conversation with a non-participant, according to one or more embodiments.

### DETAILED DESCRIPTION

According to one or more aspects of the present disclosure, the illustrative embodiments provide an electronic device, a method, and a computer program product for transcribing speech from a communication session into text in response to detecting a local participant of the communication session engaged in (or potentially distracted by) a side conversation with a non-participant while the audio input feature of the communication session is in a muted microphone mode.

An electronic device with a microphone and camera can be used to conduct audio/video (AV) communication sessions with one or more other electronic devices. During an AV communication session, a user can choose to turn on a muted mode where, during the muted mode, audio input detected by a microphone is not presented to the AV communication session.

There are occasions, during an AV communication session, when a co-worker or family member may distract an electronic device user in the AV communication session by starting a side conversation with the user. For example, a family member may interrupt an electronic device user in an AV communication session with a question about what is for dinner tonight. A co-worker may interrupt an electronic device user in an AV communication session with a question that is not related to the topic of the on-gong AV communication session.

Unfortunately, when an electronic device user is distracted by a side conversation, they can miss important details of the on-going AV communication session. For example, an electronic device user may miss conversations that include key discussion topics, decisions and agreements, assigned tasks, requirements, clarifications, and/or explanations. An electronic device user may also miss conversations that require their opinion or that request the performance of an action or task.

The embodiments disclosed herein addresses and overcome the aforementioned problems of an electronic device being used in an AV communication session when a distraction occurs while the local user has placed the device in the muted mode. One or more aspects of the embodiments disclosed herein enable an electronic device to identify if an audio transmission feature to an AV communication session is set to a muted mode. The embodiments enable the electronic device to, in response identifying the audio transmission feature is set to the muted mode, monitor for detection of audio input including spoken speech originating from an area external to the electronic device. The embodiments further enable the electronic device to detect whether there is a non-participant in a vicinity of a local participant of the AV communication session. The embodiments enable the electronic device to, in response to detecting the audio input includes spoken speech, and detecting a presence of a non-participant, identify speech input received via the AV communication session from at least one remote participant. The embodiments further enable the electronic device to generate at least one of a text transcript and/or a summary of the speech input, and visually present the text transcript or summary to the local participant.

In a first embodiment, an electronic device includes a communications subsystem that enables the electronic device to communicatively connect with at least one second electronic device via a communication session. The electronic device includes a first audio input device, and a video controller that presents video output. The electronic device includes a memory having stored thereon a communication module and a communication session speech to text (CSST) module for transcribing speech from the communication session to text. The electronic device includes at least one processor that is communicatively coupled to each of the communications subsystem, the first audio input device, the video controller, and the memory, and which executes program code of the communication module and the CSST module. The at least one processor is configured to cause the electronic device to, during a first communication session between a local participant and one or more remote participants, identify if an audio transmission feature to the first communication session of the local participant is set to a muted mode. During the muted mode, audio input detected by the first audio input device is not presented to the first communication session. In response to identifying that the audio transmission feature to the first communication session of the local participant is set to the muted mode, the at least one processor monitors, via the first audio input device, for detection of a first audio input including spoken speech originating from an area external to the electronic device. The at least one processor detects whether there is at least one non-participant in a vicinity of the local participant. In response to detecting the first audio input includes spoken speech and detecting a presence of the at least one non-participant, the at least one processor identifies speech input received via the first communication session from at least one remote participant. The at least one processor generates at least one of a text transcript and/or a summary of the speech input and visually presents the text transcript or summary to the local participant.

According to another embodiment, the method includes, during a first communication session between a local participant and one or more remote participants, identifying, via at least one processor of an electronic device, if an audio transmission feature to the first communication session of the local participant is set to a muted mode. During the muted mode, audio input detected by a first audio input device is not presented to the first communication session. In response to identifying that the audio transmission feature to the first communication session of the local participant is set to the muted mode, the method includes monitoring, via the first audio input device, for detection of a first audio input including spoken speech originating from an area external to the electronic device. The method includes detecting whether there is at least one non-participant in a vicinity of the local participant. In response to detecting the first audio input includes spoken speech and detecting a presence of the at least one non-participant, the method includes identifying speech input received via the first communication session from at least one remote participant. The method includes generating at least one of a text transcript and a summary of the speech input. The method includes visually presenting the text transcript or summary to the local participant.

According to an additional embodiment, a computer program product includes a non-transitory computer readable storage device having stored thereon program code that, when executed by at least one processor of an electronic device having a communications subsystem, a first audio input device, and a video controller that presents video output, the program code enables the electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

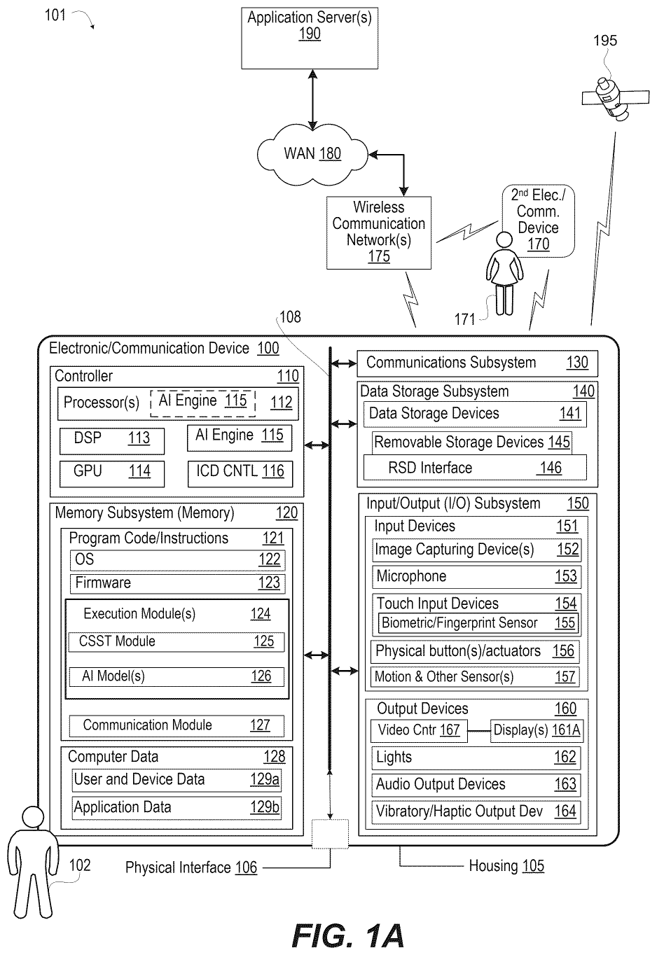

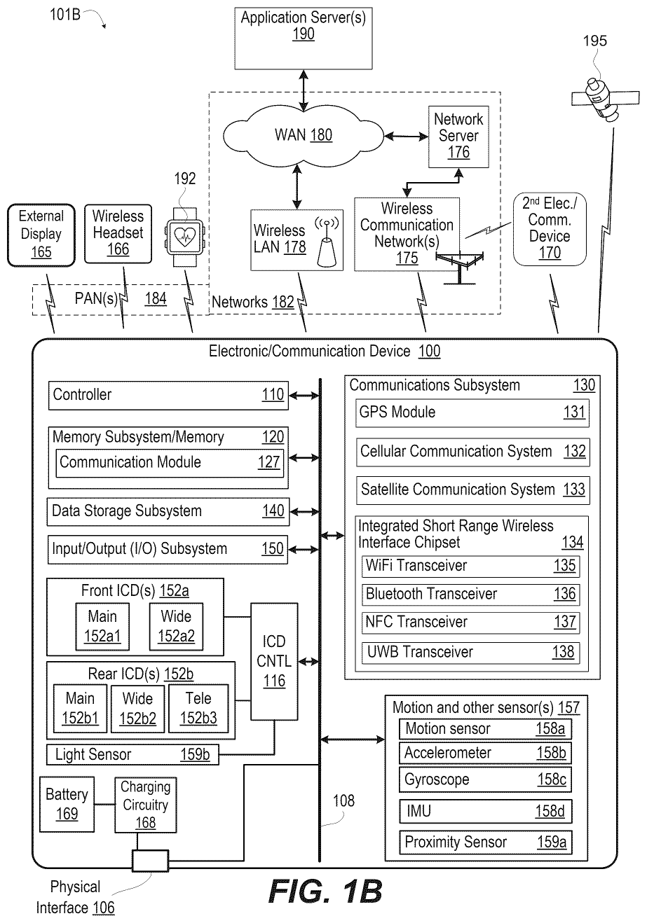

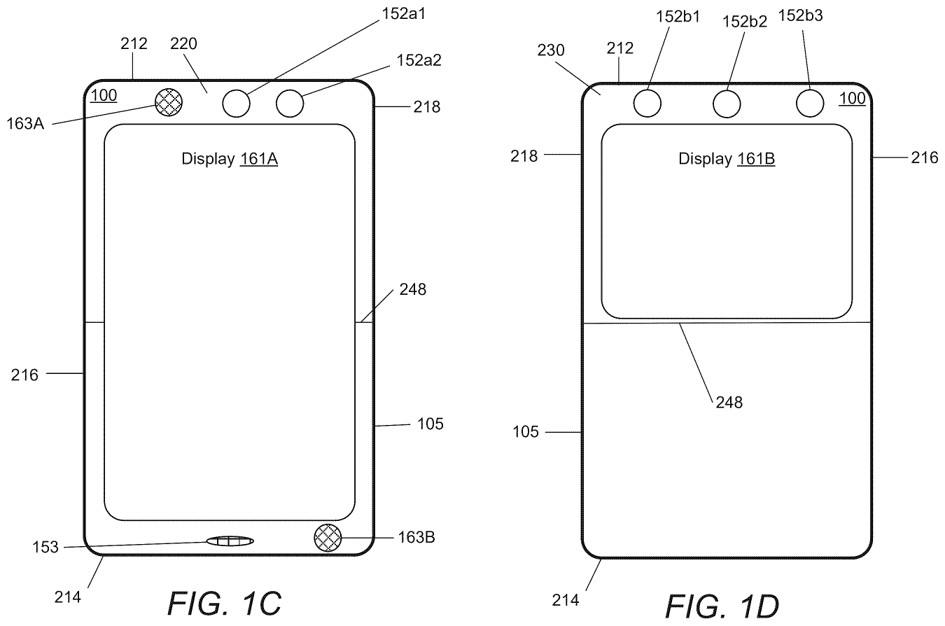

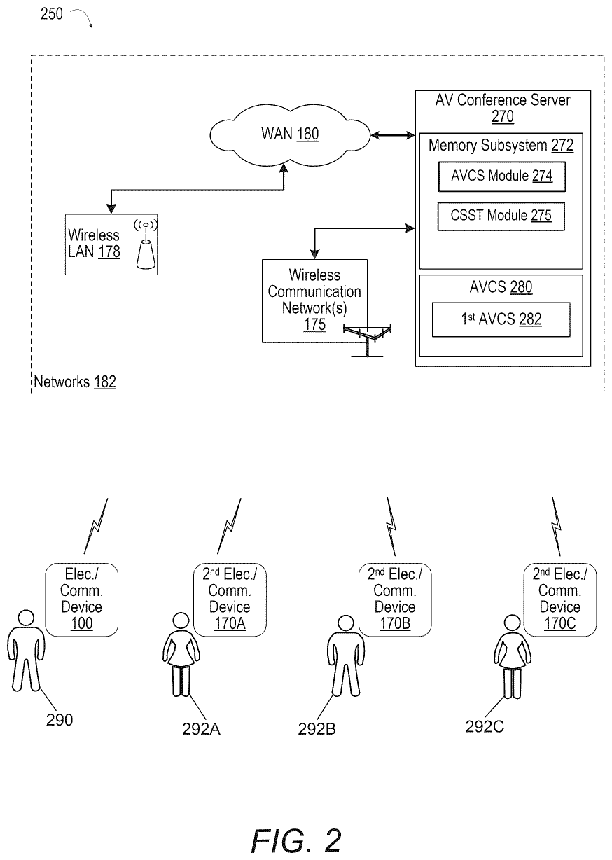

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 in a communication environment 101 and having hardware and software components, which enable the features of the present disclosure to be advantageously implemented, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices having at least one camera (or image capturing device).

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown).

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) include instructions for an operating system (OS) 122, firmware 123, such as basic input/output system (BIOS) or Uniform Extensible Firmware Interface (UEFI). Program code 121 includes execution module(s) 124 that collectively provides the various features of the disclosure.

Execution module(s) 124 include, without limitation, communication session speech to text (CSST) module 125. CSST module 125 provides the features and operating functionality of the disclosed embodiments when the corresponding program instructions of CSST module 125 are processed by/within processor 112/controller 110. Specifically, CSST module 125 provides program instructions for configuring the processor to transcribe speech from a communication session into text in response to detecting a local participant in a side conversation with a non-participant while the audio input feature of the communication session is in the muted mode.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within CSST module 125 and is trained to support the AI features of CSST module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identify the underlying features performed by processing the different modules. For example, CSST module 125 can include program instructions that cause or configure processor 112 to cause electronic device 100 to transcribe speech from a communication session to text in response to detecting a local participant in a side conversation with a non-participant. Other features provided by CSST module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices. In one embodiment, communication module 127 enables electronic device 100 to establish and connect to an audio or video communication session involving at least one second electronic device 170.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of CSST module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Microphone 153 generally represents one or more audio input devices, and there can be a plurality of such devices located at different locations of the electronic device. For example, microphone 153 can include a front microphone and a rear microphone. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voice-print, voice recognition, and/or other suitable techniques. Input devices 151 can also include one or more motion or other sensor(s) 157, which are further defined in the FIG. 1B description which follows.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, inertial measurement unit (IMU) 158d, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. IMU 158d measures force, angular rate, and orientation of electronic device 100, using a combination of accelerometers, gyroscopes, and magnetometers.

Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, video controller 167, display(s) 161, lights 162, audio output devices 163, and vibratory and/or haptic output devices 164. Video controller 167 is communicatively connected/ coupled to display(s) 161. Video controller 167 can generate and render image and video output to be presented on display(s) 161. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface 154 can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located or disposed on a rear surface of housing 105. Other embodiments provide for multiple integrated displays within electronic device 100 and references to display(s) 161 are assumed to refer to one or all of these multiple integrated displays.

Vibration/haptic output device 164 can cause electronic device 100 to vibrate or shake when activated. Vibration device 164 can be activated during an incoming call or message in order to provide an alert or notification to a user of electronic device 100. Audio output devices (e.g., a speaker) 163 can provide an audio alert or other audio output to a user. In one or more embodiments, integrated display 161, audio output devices (or speakers) 163, and vibration/haptic device 164 can generally and collectively be referred to as output devices.

With reference now to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset, but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone that is used by a second user 171, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of CSST module 125 and/or access to other applications, online transactions, and resources. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable electronic/computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can also be used as a power supply port that is coupled to charging circuitry 168, which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 include front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera 152a1 and a wide-angle camera 152a2. Rear cameras 152b can include a main camera 152b1, a wide-angle camera 152b2, and a telephoto camera 152b3. Both sets of cameras 152 include image sensors that can capture images that are within the field of view (FOV) of each respective camera 152. In one or more embodiments, one or more of the cameras can be utilized to enable biometric authentication using facial image or iris scan recognition. In one embodiment, main camera 152a1 can be a high resolution camera that is used as a webcam during a video communication session.

In the description of each of the following figures, reference is also made to specific components illustrated within the preceding figure(s). Similar or same components are presented with the same leading reference number.

Turning to FIG. 1C, additional details of the front surface of electronic device 100 are shown. Electronic device 100 includes a housing 105 that contains the components of electronic device 100. Housing 105 includes a top side 212, bottom side 214, and opposed sides 216 and 218. Housing 105 further includes a front surface 220. Electronic device 100 includes a front display 161A embedded in front surface 220 of housing 105. In some implementations, microphone 153, front display 161A, front cameras 152a1, 152a2 and audio output devices 163A and 163B are at least partially integrated or disposed into front surface 220. In one embodiment, electronic device 100 can be a foldable electronic device that folds in half along a hinge 248.

Electronic device 100 includes a first audio output device 163A and second audio output device 163B. The first audio output device 163A is disposed or located towards top side 212 of housing 105. The second audio output device 163B is disposed or located towards bottom side 214 of housing 105. Each of the audio output devices 163A and 163B are communicatively coupled to processor 112.

With additional reference to FIG. 1D, additional details of the rear surface of housing 105 of electronic device 100 are shown. Electronic device 100 includes a rear display 161B embedded in rear surface 230 of housing 105. Various components of electronic device 100 are located or disposed on/at rear surface 230, including several rear cameras. In some implementations, rear display 161B, rear main camera 152b1, rear wide-angle camera 152b2, and rear telephoto camera 152b3 are at least partially integrated or disposed into rear surface 230. In one embodiment, electronic device 100 can fold in half along hinge 248. In the folded position, rear surface 230 becomes an outer surface of electronic device 100.

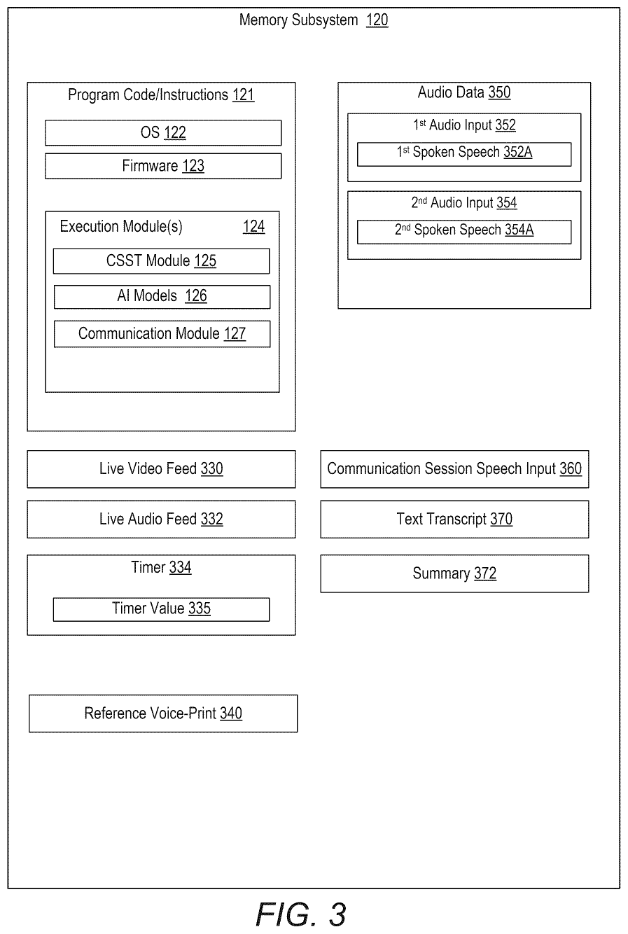

Referring to FIG. 2, an audio/video (AV) communication session environment 250 is illustrated. AV communication session environment 250 enables one or more audio and//or video communication sessions between electronic devices including electronic device 100, and several second electronic devices 170A, 170B, and 170C (170A-170C). AV communication session environment 250 includes AV conference server 270 that is communicatively connected to CWCN 175 and WAN 180 of networks 182.

AV conference server 270 includes a memory subsystem 272. Memory subsystem 272 includes an AV conference session module 274 and CSST module 275. AV conference session module 274 enables AV conference server 270 to establish and connect and facilitate audio and/or video communication sessions (AVCS) 280 involving electronic device 100 and second electronic devices 170A-170C. AV communication sessions 280 use audio and video for two-way or multi-way communication(s) between electronic device 100 and second electronic devices 170A-170C. AV communication sessions 280 include a first AV communication session 282.

CSST module 275 can provide a similar functionally for AV conference server 270 as CSST module 125 enables for electronic device 100. In an alternate embodiment, electronic device 100 can detect a local participant in a side conversation with a non-participant and trigger AV conference server 270 to transcribe speech from a communication session to text and/or a summary and transmit the transcript and/or summary to electronic device 100.

AV conference server 270 processes host-level functions for AV communication sessions 280. AV communication sessions 280 are connected by AV conference server 270 to each AV communication session connected electronic device. Electronic device 100 captures a live audio/video feed and transmits, via networks 182, the live audio/video feed to AV conference server 270. AV conference server 270 combines the audio/video received from multiple electronic devices and forwards the live audio/video feeds to the second electronic devices. Electronic device 100 presents video received from AV conference server 270 on a display (e.g., 161A or external display 165) for viewing by a local participant 290. Electronic device 100 presents audio received from AV conference server 270 on an audio output device (e.g., audio output device 163) for listening by a local participant 290. Second electronic devices 170A-170C present video received from video conference server 270 on a display for viewing by respective external or remote participants 292A, 292B, and 292C (292A-292C). Second electronic devices 170A-170C present audio received from AV conference server 270 on an audio output device for listening by respective external or remote participants 292A-292C.

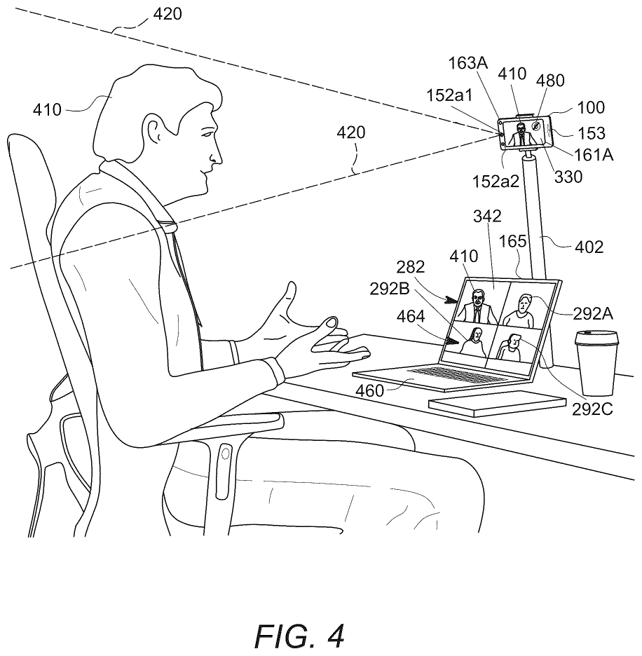

Referring to FIG. 3, there is shown one embodiment of example contents of memory subsystem 120 of electronic device 100. In the described embodiments, the contents of the memory are utilized to and/or configure electronic device 100 to complete the various processes described herein. Memory subsystem 120 includes program code/instructions 121 including data, software, and/or firmware modules, such as operating system (OS) 122, firmware 123, and execution module(s) 124. Execution module(s) 124 include CSST module 125, AI models 126, and communication module 127.

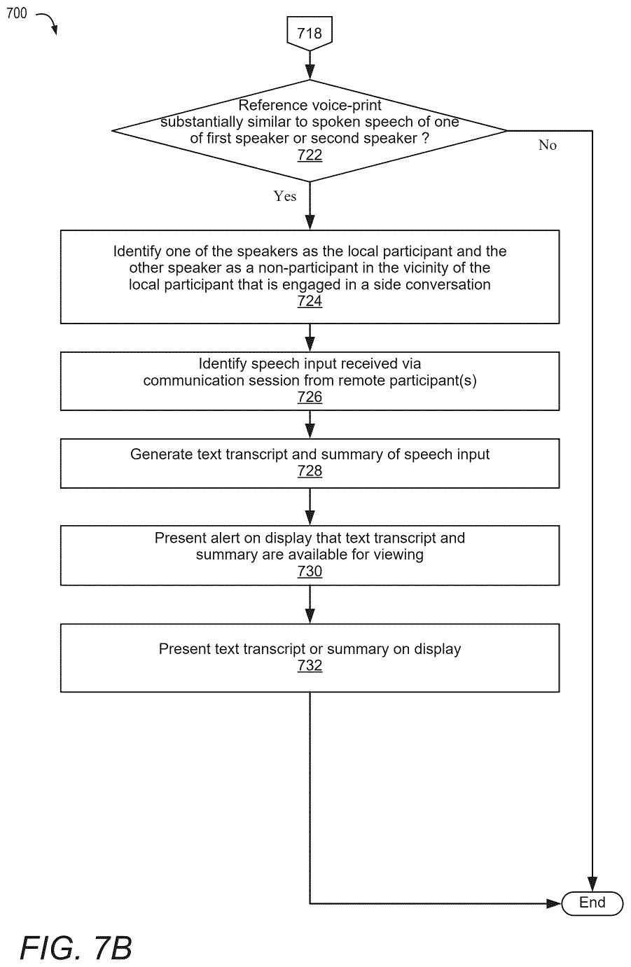

CSST module 125 includes program code that is executed by processor 112 and configures processor 112 to enable/cause electronic device 100 to perform the various features of the present disclosure. In one or more embodiments, CSST module 125 enables electronic device 100 to transcribe speech from a communication session to text in response to detecting a local participant engaged in a side conversation with a non-participant, while the device is in the muted mode, or in response to detecting that the local participant is distracted from the communication session. In one or more embodiments, execution of CSST module 125 by processor 112 configures electronic device 100 to perform the processes presented in the flowcharts of FIGS. 7A-7B, as will be described below.

AI models 126 accelerate artificial intelligence, natural language processing (NLP), context evaluation (CE), and machine learning applications. Communication module 127 enables electronic device 100 to communicate and exchange data with other devices via networks 182.

Memory subsystem 120 includes live video feed 330, live audio feed 332 and timer 334. Live video feed 330 can be captured by front main camera 152a1 of electronic device 100 in real time and be presented to one or more AV communication sessions 280. Live video feed 330 is captured within a field of view (FOV) by front main camera 152a1. In one or more alternate embodiments, a first one of rear cameras 152b, e.g., main rear camera 152b1, having a first FOV is used to capture live video feed 330 for AV communication session 280. With this alternate embodiment, a wide angle rear camera 152b2, having a wider FOV than first FOV of first rear camera 152b1 can be employed to captured the area on the periphery of the first FOV where a non-participant may approach the participant to have the side conversation, while staying off camera for the AV communication session 280.

Live audio feed 332 can be captured by microphone 153 of electronic device 100 in real time and be presented to one or more AV communication sessions 280. Timer 334 tracks a time period of receiving audio input including speech of a local participant and a non-participant that are engaged in a side conversation that is a distraction from the communication session. Timer 334 tracks a minimum amount of time that two speakers (i.e., a local participant and a non-participant) are engaged in a conversation that is deemed to be a distraction to the local participant from the communication session. As an example, a timer value 335 may be set to 10 seconds such that if a detected side conversation lasts less than 10 seconds, the side conversation is not considered to be sufficiently long to constitute a distraction.

Memory subsystem 120 includes reference voice-print 340. Reference voice-print 340 is pre-stored voice data that corresponds to the unique voice signature of a user or local participant of electronic device 100. Reference voice-print 340 can be used to identify if a local participant and/or a non-participant is/are speaking.

Memory subsystem 120 includes audio data 350. Audio data 350 is audio captured by audio input device or microphone 153 of electronic device 100. Audio data 350 includes first audio input 352 and second audio input 354. First audio input 352 includes first spoken speech 352A and second audio input 354 includes second spoken speech 354A.

Memory subsystem 120 includes communication session speech input 360, text transcript 370, and summary 372. Communication session speech input 360 is speech input received via a communication session (e.g. first AVCS 282) from at least one remote participant. Text transcript 370 is the transcribed speech input of communication session speech input 360 that has been converted or transcribed into text. Summary 372 is a brief description of the contents of text transcript 370 that provide an overview of the main ideas presented in the text transcript. In one embodiment, text transcript 370 and summary 372 are generated by processing the detected speech input 360 received via the communication session through an artificial intelligence engine utilizing natural language processing to generate the text transcript and processing the text transcript through the artificial intelligence engine to generate the summary.

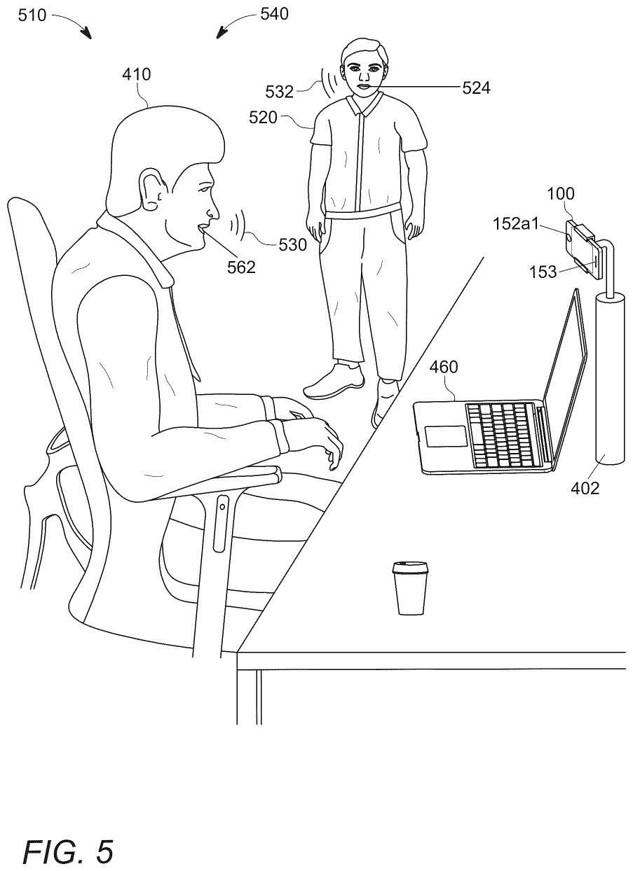

Referring to FIG. 4, electronic device 100 has been positioned to capture live video and audio of a local participant 410 during a first AV communication session 282. Local participant 410 is participating in first AV communication session 282. Electronic device 100 is mounted to a stand 402 with display 161A and front cameras 152a1, 152a2 facing toward local participant 410. Front main camera 152a1 has a field of view (FOV) 420 that includes images and video of the local participant 410. Microphone 153 can capture audio input (i.e. speech) spoken by local participant 410 and can present the audio input to the first AV communication session 282.

In some embodiments, the first AV communication session 282 can be presented to the local participant 410 via an external display 165 that is communicatively connected to electronic device 100. In one embodiment, external display 165 can be the display of laptop computer 460. The first video communication session 282, shown on external display 165, can include several other remote participants 292A-292C that are shown in one or more sub-windows/frames 464. At least one of sub-windows 464 can include the local participant 410. In one embodiment, when the communication session is an audio communication session, the audio of first communication session 282 can be presented to the local participant 410 via speaker 163A.

In one embodiment, front main camera 152a1 can be a high-resolution camera that is used as a webcam during the first AV communication session 282. Front main camera 152a1 can have an improved video quality as compared to a camera of laptop computer 460. In FIG. 4, during the first AV communication session 282, live video feed 330 is shown being presented to the AV communication session on front display 161A.

In one embodiment, an audio transmission feature of the first AV communication session 282 can be set to a muted mode as indicated by muted mode icon 480 on display 161A. During the muted mode, audio input such as spoken speech of the local participant 410 is detected by the audio input device/microphone 153, but is not presented to the first AV communication session 282. In other words, the local participant 410 is listening to audio (i.e., spoken speech) provided by one or more remote participants 292A-292C during the first AV communication session, and live audio 332 generated by the local participant and/or originating in the environment around the local participant is not being presented to the communication session.

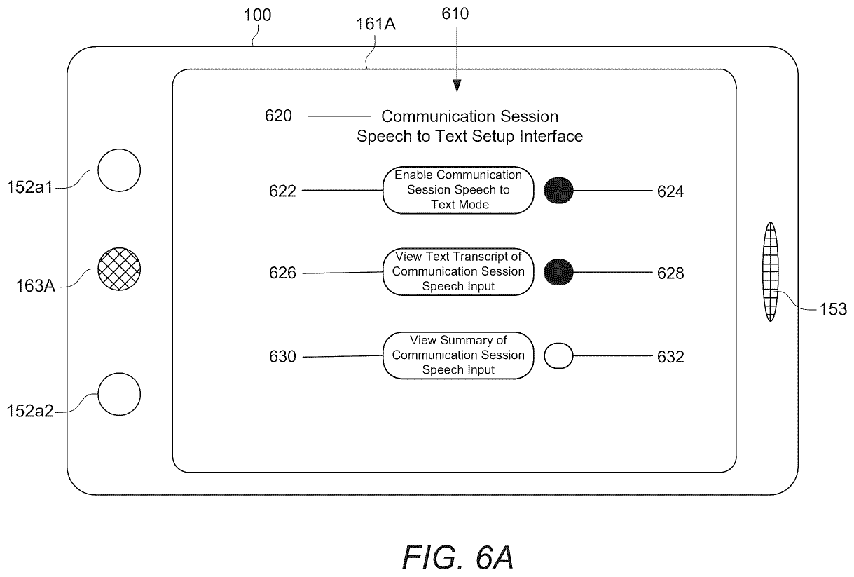

Turning to FIG. 5, a scene 510 is shown of the local participant 410 engaged in a side conversation 540 with a non-participant 520, while the first AV communication session 282 is on-going. In one embodiment, non-participant 520 may have interrupted and distracted local participant 410 during the first AV communication session 282 such that the local participant may miss some of the ongoing exchange of content within the first AV communication session 282. In FIG. 5, local participant 410 has turned toward non-participant 520 and is engaged in or listening to (and potentially distracted by) side conversation 540. During example side conversation 540, local participant 410 is speaking or uttering spoken speech 530 and non-participant 520 is speaking or uttering spoken speech 532. Local participant 410 has a mouth 562 that moves during speech 530 and non-participant 520 has a mouth 524 that moves during speech 532. It is appreciated that in other embodiments, only one of the two people may be speaking. In the described embodiment, local participant 410 is referred to as a first speaker and non-participant 520 is referred to as a second speaker. During the first AV communication session 282, microphone 153 can be used to monitor for detection of audio input (e.g., first audio input 352) including spoken speech (e.g., spoken speech 530, 532) originating from an area external to the electronic device. The process by which the processor is able to distinguish between (and/or separate out) speech from outside the device and speech received at the device and presented via the speaker is known to those skilled in the art.

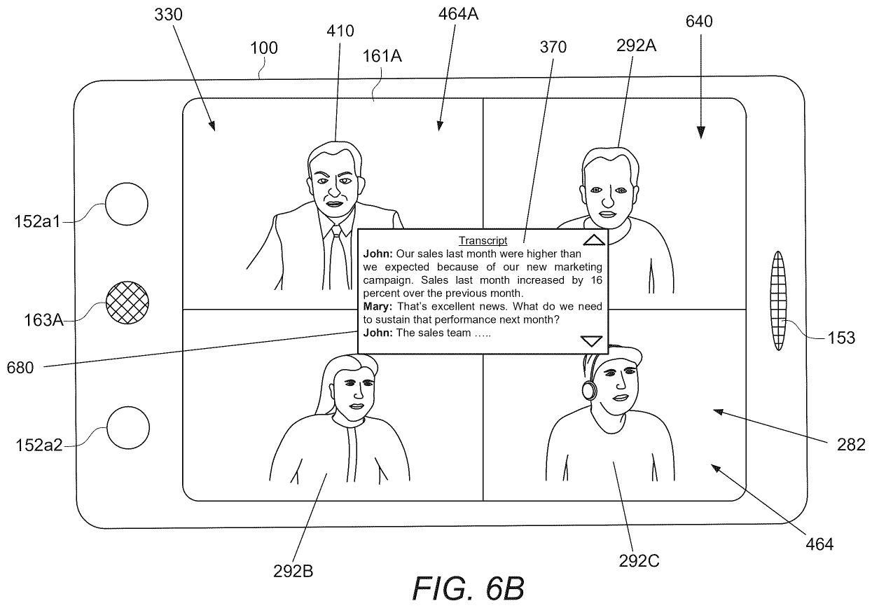

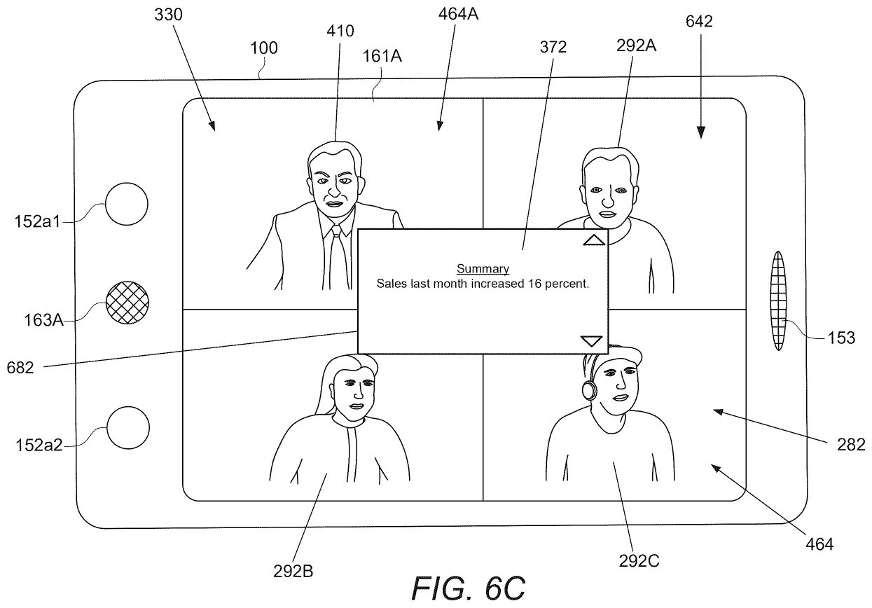

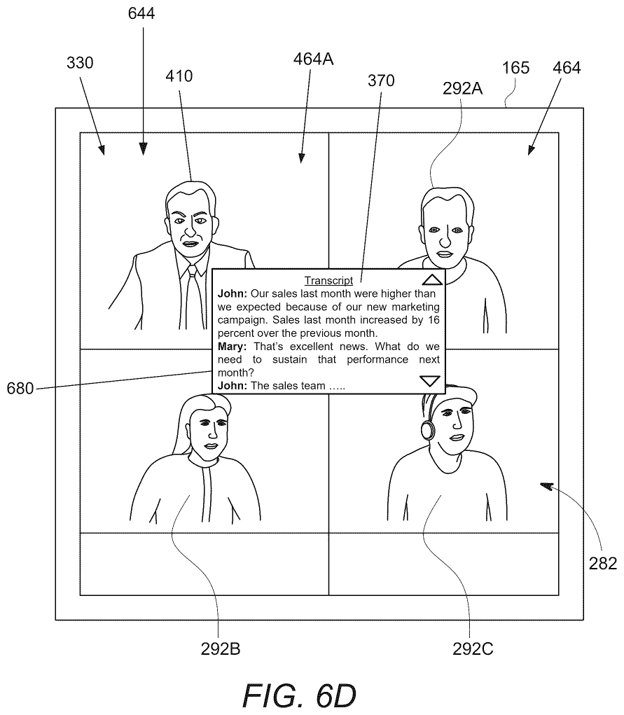

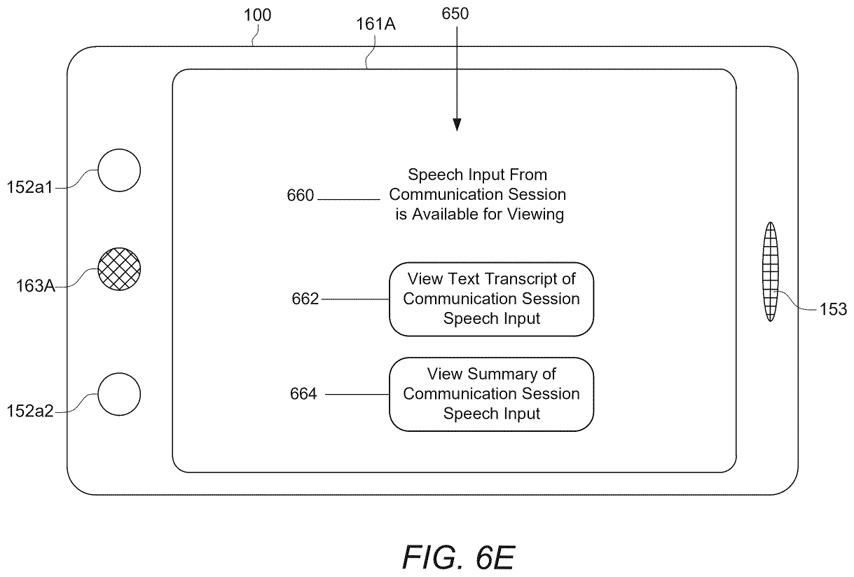

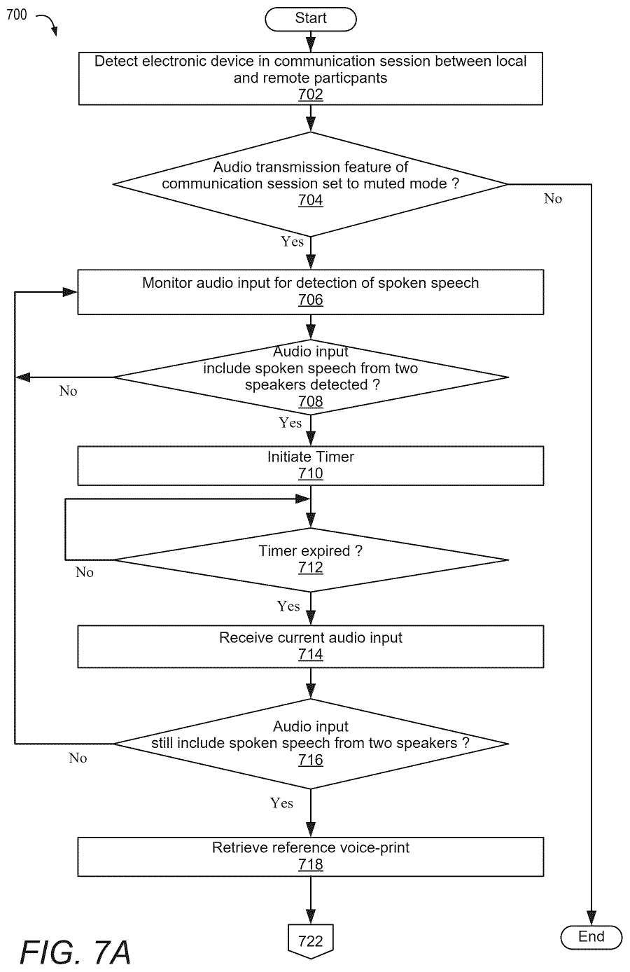

FIG. 6A illustrates an example setup graphical user interface (GUI) 610 presented on display 161A of electronic device 100. Setup GUI 610 can be configured by the user of electronic device 100. Setup GUI 610 includes a user-selectable enable communication session speech to text (CSST) during user distraction option 622 and on/off indicator 624. Enable CSST option 622 allows a user of electronic device 100 to initiate autonomous speech transcription from a communication session into text in response to detecting a local participant in a side conversation with a non-participant while the audio input feature of the communication session is in the muted mode.

Setup GUI 610 includes a user-selectable view text transcript of AV communication session speech input option 626 and on/off indicator 628. The selection of view text transcript option 626 causes text transcript 370 to be generated and presented on display 161A and/or external display 165. Setup interface GUI 610 includes a user-selectable view summary of AV communication session speech input option 630 and on/off indicator 632. The selection of view summary option 630 causes summary 372 to be generated and presented on display 161A and/or external display 165. In FIG. 6A a user has selected enable CSST option 622 with corresponding indicator 624 darkened or checked and has selected view text transcript option 626 with corresponding indicator 628 darkened or checked.

In one embodiment, the user selection of enable CSST option 622 triggers the capturing, via the audio input device 153, of a sample of the local participant 410 speaking. Electronic device 100 identifies the captured sample audio input of the local participant as the reference voice-print 340 of the local participant and stores the reference voice-print 340 to memory 120.

Referring to FIG. 6B, electronic device 100 is shown presenting AV communication session GUI 640 which presents/includes text transcript 370 after electronic device 100 detects that the local participant is engaged in a side conversation with a non-participant, while the local audio input setting of the communication session is in the muted mode. With this embodiment, electronic device 100 is operating with the setup interface settings of FIG. 6A, as configured by the user of electronic device 100. In response to detecting that the local participant is engaged in a side conversation with a non-participant, electronic device 100 autonomously processes the detected communication session speech input (e.g., speech input 360 that is received via the communication session) through an artificial intelligence engine utilizing natural language processing to generate the text transcript 370, and electronic device 100 presents the text transcript 370 in a separate sub-window/frame 680 within the communication session GUI. In one embodiment, presentation of the text transcript is autonomously triggered by the detection of spoken speech from side conversation 540 including the local participant 410 and the non-participant 520.

In FIG. 6B, live video feed 330 of local participant 410 is shown in sub-window/frame 464A and the other remote participants 292A-292C are shown in corresponding ones of other sub-windows/frames 464. During or after the side conversation, local participant 410 can turn their attention back towards viewing display 161A to view text transcript 370 and be informed of the contents of the on-going first AV communication session 282 provided by the remote participants 292A-292C.

Referring to FIG. 6C, electronic device 100 is shown presenting AV communication session GUI 642, which presents/includes summary 372, generated after electronic device 100 detects that the local participant is engaged in a side conversation with a non-participant, while the local audio input setting of the communication session is in the muted mode. With this embodiment, view summary option 630 of FIG. 6A has been selected/configured by the user of electronic device 100. In response to detecting that the local participant is engaged in a side conversation with a non-participant, electronic device 100 autonomously processes the detected speech input (e.g., speech input 360) received via the communication session through an artificial intelligence engine utilizing natural language processing to generate the text transcript 370. Electronic device 100 then processes the text transcript 370 through the artificial intelligence engine to generate the summary 372. Electronic device 100 processes the text transcript 370 through the artificial intelligence engine to generate the summary 372 and electronic device 100, presents the summary 372 on front display 161A in a separate sub-window/frame 682 within the communication session GUI. In one embodiment, presentation of the summary is autonomously triggered by the detection of spoken speech from side conversation 540 including the local participant 410 and the non-participant 520.

In FIG. 6C, live video feed 330 of local participant 410 is shown in sub-window/frame 464A and the other remote participants 292A-292C are shown in corresponding ones of other sub-windows/frames 464. During or after the side conversation, local participant 410 can turn their attention back towards viewing display 161A to view summary 372 and be informed of the contents of the on-going first AV communication session 282 provided by the remote participants 292A-292C.

With reference to FIG. 6D, external display 165 of laptop computer 460 is shown presenting AV communication session GUI 644, which presents/includes text transcript 370 that is generated and presented after electronic device 100 detects that the local participant is engaged in a side conversation with a non-participant while the local audio input setting of the communication session is in the muted mode. In response to detecting that the local participant is engaged in a side conversation with a non-participant, electronic device 100 autonomously processes the detected speech input (e.g., communication session speech input 360) received via the communication session through an artificial intelligence engine utilizing natural language processing to generate the text transcript 370 and presents the text transcript 370 in a separate sub-window/frame 680. In one embodiment, text transcript 370 can be presented on one side of the display in a separate sub-window/frame.

In FIG. 6D, live video feed 330 of local participant 410 is shown in sub-window/frame 464A and the other remote participants 292A-292C are shown in corresponding ones of other sub-windows/frames 464. During or after the side conversation, local participant 410 can turn their attention back towards viewing external display 165 to view text transcript 370 and be informed of the contents of the on-going first AV communication session 282 provided by the remote participants 292a-292c.

FIG. 6E illustrates an example text transcript/summary notification GUI 650 presented on display 161A of electronic device 100 after the electronic device has detected spoken speech from the side conversation 540 and generated at least one of a text transcript and a summary of the spoken speech. In one embodiment, presentation of text transcript/summary notification GUI 650 is triggered by the detection of spoken speech from side conversation 540 including the local participant 410 and the non-participant 520.

Text transcript/summary notification GUI 650 includes an alert or notification 660 that speech input 360 received via an AV communication session from at least one remote participant (e.g., at least one of remote video conference participants 292A-292C) is available for viewing. Text transcript/summary notification GUI 650 includes a user-selectable view text transcript of AV communication session speech input option 662 and a user-selectable view summary of AV communication session speech input option 664.

The selection of view text transcript option 662 causes text transcript 370 to be generated and presented on display 161A and/or external display 165. The selection of view summary option 664 causes summary 372 to be generated and presented on display 161A and/or external display 165. The user selectable options 662, 664 are removed following expiration of a time-out period for user selection when no selection is received. In one or more embodiments, the text transcript/summary notification GUI 650 is stored on the local device and is accessible after termination of the communication session for access by the local participant on demand.

According to one aspect of the disclosure, during a first AV communication session 282 between a local participant 410 and one or more remote participants 292A-292C, electronic device 100 identifies if an audio transmission feature to the first AV communication session 282 of the local participant is set to a muted mode. During the muted mode, audio input detected by audio input device 153 is not presented to the first AV communication session 282. In response to identifying that the audio transmission feature to the first AV communication session 282 of the local participant is set to the muted mode, electronic device 100 monitors, via audio input device 153, for detection of first audio input 352 including spoken speech 352A originating from an area external to the electronic device. Electronic device 100 detects whether there is at least one non-participant 520 in a vicinity of the local participant 410. In response to detecting the first audio input 352 includes spoken speech 352A and detecting a presence of the at least one non-participant 520, electronic device 100 identifies speech input 360 received via the first AV communication session 282 from at least one remote participant 292A-292C. Electronic device 100 generates at least one of a text transcript 370 and a summary 372 of the speech input 360. Electronic device 100 visually presents the text transcript 370 or summary 372 to the local participant 410.

According to another aspect of the disclosure, to determine if the first audio input 352 includes spoken speech 352A, electronic device 100 determines if the first audio input 352 includes spoken speech 352A of the local participant 410. Electronic device 100 triggers the generation of the voice transcription (i.e., text transcript 370) in response to the first audio input including the spoken speech of the local participant.

According to an additional aspect of the disclosure, to determine if the first audio input 352 includes spoken speech 352A of the local participant 410, electronic device 100 retrieves a reference voice-print 340 of the local participant 410. Electronic device 100 determines if the reference voice-print 340 is substantially similar to at least a portion of the first audio input 352. In response to determining the reference voice-print 340 is substantially similar to at least a portion of the first audio input 352, electronic device 100 identifies the speech in the portion of first audio input 352 as that of the local participant and triggers a text transcript generation feature for the speech input 360 received via the first AV communication session 282 from at least one remote participant.

According to a further aspect of the disclosure, to detect whether there is at least one non-participant 520 in a vicinity of the local participant 410, electronic device 100 retrieves a reference voice-print 340 of the local participant 410 and determines if the reference voice-print 340 is substantially similar to at least a portion of the first audio input 352 that includes spoken speech 352A. In response to determining the reference voice-print 340 is not substantially similar to at least a portion of the first audio input 352, electronic device 100 identifies a presence of the at least one non-participant 520 in a vicinity of the local participant 410.

According to one more aspect of the disclosure, electronic device 100 presents, on a first display 161A, an alert or notification 660 indicating that the text transcript 370 or summary 372 of the speech input 360 received from the first AV communication session 282 is available for viewing. Electronic device 100 presents the text transcript 370 or summary 372 on at least one of the first display 161A and a remote display 165 communicatively coupled to the electronic device, in response to a selection by the local participant 410 to view the text transcript or summary.

According to yet another aspect of the disclosure, electronic device 100 detects a terminating event of the first AV communication session 282 and presents the text transcript 370 or summary 372 in response to detecting the terminating event.

According to a further aspect of the disclosure, to generate the summary 372 of the speech input, electronic device 100 processes the detected speech input 360 received via the first communication session 282 through an artificial intelligence engine 115, 126 utilizing natural language processing to generate the text transcript 370. Electronic device 100 process the text transcript 370 through the artificial intelligence engine to generate the summary 372.

According to one or more additional aspect(s) of the disclosure, to determine if the first audio input 352 includes spoken speech, electronic device 100 determines that the first audio input 352 includes speech of a plurality of speakers comprising a first speaker and a second speaker. In response to determining the first audio input 352 includes speech of the plurality of speakers, electronic device 100 determines if speech of one of the first speaker and the second speaker is substantially similar to a pre-stored reference voice-print 340 of the local participant 410. In response to determining the reference voice-print 340 is substantially similar to speech of one of the first speaker or the second speaker, electronic device 100 identifies a corresponding one of the first speaker and the second speaker as the local participant who is speaking.

According to still another aspect of the disclosure, in response to determining the first audio input 352 includes speech of the plurality of speakers, electronic device 100 initiates a first timer 334 tracking a first time period of receiving the first audio input 352 including speech of the first speaker and the second speaker. Electronic device 100 determines if the first timer 334 has expired. In response to determining the first timer 334 has expired, electronic device 100 identifies whether the first speaker and the second speaker are still engaged in a side conversation 540 that is potentially a distraction to the local participant from the on-going communication session and triggers the determining of whether speech of one of the first speaker and the second speaker is substantially similar to the pre-stored reference voice-print 340 of the local participant.

According to one more additional aspect of the disclosure, in response to detecting setup/activation of a CSST mode of the electronic device for responding to audio distractions involving the local participant while a local audio input setting of the communication session is in a muted mode, electronic device 100 determines if a reference voice-print 340 of the local participant 410 has been stored. In response to determining the reference voice-print 340 of the local participant has not been stored, electronic device 100 captures, via the audio input device 153, a sample of the local participant 410 speaking. Electronic device 100 identifies the captured sample audio input of the local participant as the reference voice-print 340 of the local participant and stores the reference voice-print 340 to memory 120.

FIGS. 7A-7B (FIG. 7) depicts a flow chart presenting method 700 by which electronic device 100 transcribes speech from a communication session to text in response to detecting a local participant of the communication session in a side conversation with a non-participant while the device microphone input is in a muted mode. The description of method 700 will be described with reference to the components and examples of FIGS. 1-6D. The operations depicted in FIGS. 7A-7B can be performed by electronic device 100 or any suitable electronic device that includes the one or more functional components of electronic device 100 that provide/enable the described features. One or more of the processes of the methods described in FIGS. 7A-7B may be performed by processor 112 executing program code associated with CSST module 125.

With specific reference to FIG. 7A, method 700 begins at the start block. At block 702, method 700 includes detecting that electronic device 100 is in a first AV communication session 282 between local participant 410 and one or more remote participants 292A-292C. Method 700 includes identifying if an audio transmission feature to the first AV communication session 282 of the local participant is set to a muted mode (decision block 704). During the muted mode, audio input detected by audio input device 153 is not presented to the first AV communication session 282. In response to identifying that the audio transmission feature to the first AV communication session 282 of the local participant is not set to the muted mode, method 700 ends at the end block.

In response to identifying that the audio transmission feature to the first AV communication session 282 of the local participant is set to the muted mode, method 700 includes monitoring, via audio input device 153, for detection of first audio input 352 including first spoken speech 352A originating from an area external to the electronic device (block 706). In an alternative embodiment, decision block 704 of method 700 can include detecting if the electronic device user has muted microphone 153 and in response to detecting the user has muted microphone 153, method 700 includes activating the transcript/summary generation feature and initiating monitoring, via audio input device 153, for detection of first audio input 352 at block 706. Method 700 includes determining if the first audio input 352 includes first spoken speech 352A of two or more speakers has been detected (decision block 708). In response to determining that the first audio input 352 including first spoken speech 352A has not been detected, method 700 returns to block 706 to continue monitoring for detection of first audio input 352 including spoken speech 352A. In response to determining that the first audio input 352 including first spoken speech 352A of two or more speakers has been detected, method 700 includes initiating timer 334 (block 710). Timer 334 tracks a time period of receiving audio input including speech of two or more speakers that are engaged in a side conversation. Method 700 includes determining if timer 334 has expired (decision block 712).

In response to determining timer 334 has not expired, method 700 continues to determine if timer 334 has expired at decision block 712. In response to determining timer 334 has expired, method 700 includes receiving, via audio input device 153, current audio input (e.g., second audio input 354) (block 714). Method 700 includes determining if the current audio input still includes spoken speech (e.g. second spoken speech 354A) of two or more speakers that are still engaged in a side conversation (decision block 716).

In response to determining the current audio input does not includes spoken speech of two or more speakers that are engaged in a side conversation, method 700 returns to block 706 to continue monitoring for detection of first audio input 352 including spoken speech 352A. In response to determining the current audio input includes spoken speech (e.g. second spoken speech 354A) of two or more speakers that are still engaged in a side conversation, method 700 includes retrieving reference voice-print 340 (block 718).

Turning to FIG. 7B, at decision block 722, method 700 includes determining if speech of one of the first speaker and the second speaker is substantially similar to a pre-stored reference voice-print 340 of the local participant 410. In response to determining speech of one of the first speaker and the second speaker is not substantially similar to the pre-stored reference voice-print 340, method 700 terminates at the end block. In response to determining speech of one of the first speaker and the second speaker is substantially similar to the pre-stored reference voice-print 340, method 700 includes identifying a corresponding one of the first speaker and the second speaker as the local participant who is speaking and identifying the other speaker as the non-participant that is engaged in a side conversation in a vicinity of the local participant (block 724).

Method 700 includes activating a transcript/summary generation mode and identifying speech input 360 received via the first AV communication session 282 from at least one of the remote participant(s) 292A-292C (block 726). Method 700 includes generating at least one of a text transcript 370 and/or summary 372 of the speech input 360 (block 728). In one embodiment, text transcript 370 and summary 372 are generated by processing the detected speech input 360 received via the communication session through an artificial intelligence engine utilizing natural language processing to generate the text transcript 370 and subsequently processing the text transcript 370 through the artificial intelligence engine to generate the summary 372.

Method 700 includes presenting an alert or notification 660 on display 161A or external display 165 that the text transcript 370 and/or summary 372 are available for viewing (block 730). Method 700 includes visually presenting the text transcript 370 or summary 372 on display 161A or external display 165 to the local participant 410 (block 732). Method 700 ends at the end block.

In one embodiment, the text transcript 370 and/or the summary 372 can be automatically/autonomously presented for viewing by the local participant after detecting that the local participant is engaged in a side conversation with a non-participant. In another embodiment, a user selectable option (e.g., view text transcript option 662 and view summary option 664) can be presented to the local participant to select which of the text transcript 370 or summary 372 are presented on display 161A.

The disclosure provides improvements in an electronic device being used in an AV communication session by enabling the electronic device to monitor for detection of audio input including spoken speech originating from an area external to the electronic device in response to identifying that an audio transmission feature to the AV communication session is set to a muted mode. Further, the disclosure enables the electronic device to detect whether there is at least one non-participant in a vicinity of a local participant of the AV communication session who is engaged in a side conversation.

The disclosure enables the electronic device to identify speech input from the AV communication session from at least one remote participant in response to detecting the non-participant engaged in a side conversation with the local participant. The disclosure enables the electronic device to generate at least one of a text transcript and a summary of the speech input and visually present the text transcript or summary to the local participant.

In the above-described methods of FIGS. 7A-7B, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined primarily by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a communications subsystem that enables the electronic device to communicatively connect with at least one second electronic device via a communication session;
a first audio input device;
a video controller that presents video output;
a memory having stored thereon a communication module and a communication session speech to text (CSST) module for transcribing speech from the communication session to text; and
at least one processor communicatively coupled to each of the communications subsystem, the first audio input device, the video controller, and the memory, and which executes program code of the communication module and the CSST module, the at least one processor configured to cause the electronic device to:
during a first communication session between a local participant and one or more remote participants, identify if an audio transmission feature to the first communication session of the local participant is set to a muted mode, wherein during the muted mode, audio input detected by the first audio input device is not presented to the first communication session;
in response to identifying that the audio transmission feature to the first communication session of the local participant is set to the muted mode, monitor, via the first audio input device, for detection of a first audio input including spoken speech originating from an area external to the electronic device;
detect whether there is at least one non-participant in a vicinity of the local participant; and
in response to detecting the first audio input includes spoken speech and detecting a presence of the at least one non-participant:
identify speech input received via the first communication session from at least one remote participant;
generate at least one of a text transcript and a summary of the speech input; and
visually present the text transcript or summary to the local participant.

2. The electronic device of claim 1, wherein to determine if the first audio input includes spoken speech, the at least one processor is further configured to cause the electronic device to:
determine if the first audio input includes spoken speech of the local participant; and
trigger the generation of the voice transcription in response to the first audio input including the spoken speech of the local participant.

3. The electronic device of claim 2, wherein to determine if the first audio input includes spoken speech of the local participant, the at least one processor is further configured to cause the electronic device to:
retrieve a reference voice-print of the local participant;
determine if the reference voice-print is substantially similar to at least a portion of the first audio input; and
in response to determining the reference voice-print is substantially similar to at least a portion of the first audio input, trigger a text transcript generation feature for the speech input received via the first communication session from at least one remote participant.

4. The electronic device of claim 1, wherein to detect whether there is at least one non-participant in a vicinity of the local participant, the at least one processor is further configured to cause the electronic device to:
retrieve a reference voice-print of the local participant;
determine if the reference voice-print is substantially similar to at least a portion of the first audio input that includes spoken speech; and
in response to determining the reference voice-print is not substantially similar to at least a portion of the first audio input, identify a presence of the at least one non-participant in a vicinity of the local participant.

5. The electronic device of claim 1, further comprising a first display communicatively coupled to the video controller and the at least one processor, wherein the at least one processor is further configured to cause the electronic device to:
present, on the first display, an alert indicating that the text transcript or summary of the speech input received from the first communication session is available for viewing; and
present the text transcript or summary on at least one of the first display and a remote display communicatively coupled to the electronic device, in response to a selection by the local participant to view the text transcript or summary.

6. The electronic device of claim 1, wherein the at least one processor is further configured to cause the electronic device to:
detect a terminating event of the first communication session; and
present the text transcript or summary in response to detecting the terminating event.

7. The electronic device of claim 1, wherein to generate the summary of the speech input, the at least one processor is further configured to cause the electronic device to:
process the detected speech input received via the first communication session through an artificial intelligence engine utilizing natural language processing to generate the text transcript; and
process the text transcript through the artificial intelligence engine to generate the summary.

8. The electronic device of claim 1, wherein to determine if the first audio input includes spoken speech, the at least one processor is further configured to cause the electronic device to:
determine that the first audio input includes speech of a plurality of speakers comprising a first speaker and a second speaker;
in response to determining the first audio input includes speech of the plurality of speakers, determine if speech of one of the first speaker and the second speaker is substantially similar to a pre-stored reference voice-print of the local participant; and
in response to determining the reference voice-print is substantially similar to speech of one of the first speaker or the second speaker, identify a corresponding one of the first speaker and the second speaker as the local participant who is speaking.

9. The electronic device of claim 8, wherein the at least one processor is further configured to cause the electronic device to:
in response to determining the first audio input includes speech of the plurality of speakers:
initiate a first timer tracking a first time period of receiving the first audio input including speech of the first speaker and the second speaker;
determine if the first timer has expired;
in response to determining the first timer has expired, identify whether the first speaker and the second speaker are still engaged in a side conversation; and
trigger the determining of whether speech of one of the first speaker and the second speaker is substantially similar to the pre-stored reference voice-print of the local participant.

10. The electronic device of claim 1, wherein the at least one processor is further configured to cause the electronic device to:
in response to detecting setup/activation of a CSST mode of the electronic device for responding to audio distractions involving the local participant while a local audio input setting of the communication session is in a muted mode,, determine if a reference voice-print of the local participant has been stored; and
in response to determining the reference voice-print of the local participant has not been stored:
capture, via the first audio input device, a sample of the local participant speaking;
identify the captured sample audio input of the local participant as the reference voice-print of the local participant; and
store the reference voice-print to the memory.

11. A method comprising:
during a first communication session between a local participant and one or more remote participants, identifying, via at least one processor of an electronic device, if an audio transmission feature to the first communication session of the local participant is set to a muted mode, wherein during the muted mode, audio input detected by a first audio input device is not presented to the first communication session;
in response to identifying that the audio transmission feature to the first communication session of the local participant is set to the muted mode, monitoring, via the first audio input device, for detection of a first audio input including spoken speech originating from an area external to the electronic device;
detecting whether there is at least one non-participant in a vicinity of the local participant; and
in response to detecting the first audio input includes spoken speech and detecting a presence of the at least one non-participant:
identifying speech input received via the first communication session from at least one remote participant;
generating at least one of a text transcript and a summary of the speech input; and
visually presenting the text transcript or summary to the local participant.

12. The method of claim 11, wherein to determine if the first audio input includes spoken speech, the method further comprises:
determining if the first audio input includes spoken speech of the local participant; and
triggering the generation of the voice transcription in response to the first audio input including the spoken speech of the local participant.

13. The method of claim 12, wherein to determine if the first audio input includes spoken speech of the local participant, the method further comprises:
retrieving a reference voice-print of the local participant;
determining if the reference voice-print is substantially similar to at least a portion of the first audio input; and
in response to determining the reference voice-print is substantially similar to at least a portion of the first audio input, triggering a text transcript generation feature for the speech input received via the first communication session from at least one remote participant.

14. The method of claim 11, wherein to detect whether there is at least one non-participant in a vicinity of the local participant, the method further comprises:
retrieving a reference voice-print of the local participant;
determining if the reference voice-print is substantially similar to at least a portion of the first audio input that includes spoken speech; and
in response to determining the reference voice-print is not substantially similar to at least a portion of the first audio input, identifying a presence of the at least one non-participant in a vicinity of the local participant.

15. The method of claim 11, further comprising:
presenting, on a first display, an alert indicating that the text transcript or summary of the speech input received from the first communication session is available for viewing; and
presenting the text transcript or summary on at least one of the first display and a remote display communicatively coupled to the electronic device, in response to a selection by the local participant to view the text transcript or summary.

16. The method of claim 11, further comprising:
detecting a terminating event of the first communication session; and
presenting the transcript or summary in response to detecting the terminating event.

17. The method of claim 11, wherein to generate the summary of the speech input, the method further comprises:
processing the detected speech input received via the first communication session through an artificial intelligence engine utilizing natural language processing to generate the text transcript; and
processing the text transcript through the artificial intelligence engine to generate the summary.

18. The method of claim 11, wherein to determine if the first audio input includes spoken speech, the method further comprises:
determining that the first audio input includes speech of a plurality of speakers comprising a first speaker and a second speaker;
in response to determining the first audio input includes speech of the plurality of speakers, determining if speech of one of the first speaker and the second speaker is substantially similar to a pre-stored reference voice-print of the local participant; and
in response to determining the reference voice-print is substantially similar to speech of one of the first speaker or the second speaker, identifying a corresponding one of the first speaker and the second speaker as the local participant who is speaking.

19. The method of claim 18, further comprising:
in response to determining the first audio input includes speech of the plurality of speakers:
initiating a first timer tracking a first time period of receiving the first audio input including speech of the first speaker and the second speaker;
determining if the first timer has expired;
in response to determining the first timer has expired, identifying whether the first speaker and the second speaker are still engaged in a side conversation; and
triggering the determining of whether speech of one of the first speaker and the second speaker is substantially similar to the pre-stored reference voice-print of the local participant.

20. A computer program product comprising:
a computer readable storage device having stored thereon program code which, when executed by at least one processor of an electronic device having a communications subsystem that enables the electronic device to communicatively connect with at least one second electronic device via a communication session, a first audio input device, and a video controller that presents video output, configures the electronic device to complete the functionality of:
during a first communication session between a local participant and one or more remote participants, identifying if an audio transmission feature to the first communication session of the local participant is set to a muted mode, wherein during the muted mode, audio input detected by the first audio input device is not presented to the first communication session;
in response to identifying that the audio transmission feature to the first communication session of the local participant is set to the muted mode, monitoring, via the first audio input device, for detection of a first audio input including spoken speech originating from an area external to the electronic device; detecting whether there is at least one non-participant in a vicinity of the local participant; and
in response to detecting the first audio input includes spoken speech and detecting a presence of the at least one non-participant:
identifying speech input received via the first communication session from at least one remote participant;
generating at least one of a text transcript and a summary of the speech input; and
visually presenting the text transcript or summary to the local participant.
